(19) United States
(12) Patent Application Publication
(10) Pub. No.: US 2026/0326323 A1
(43) Pub. Date: Oct. 22, 2026

(54) VACUUM-POWERED HAIRCUTTING ATTACHMENT WITH STRUCTURALLY DEFINED CUTTING LENGTH AND SKIN ISOLATION

(71) Applicant: Zhengwen Liu, Bollnas (SE)

(72) Inventor: Zhengwen Liu, Bollnas (SE)

(21) Appl. No.: 19/468,279

(22) Filed: Feb. 3, 2026

(51) Int. Cl. B26B 19/34; B26B 19/14; B26B 19/20; B26B 19/44

(52) U.S. Cl. CPC B26B 19/34; B26B 19/141; B26B 19/205; B26B 19/44

(57) ABSTRACT

A vacuum-powered haircutting attachment includes a housing defining an airflow passage, an inlet opening arranged as a primary airflow entry, and a cutting assembly driven by airflow from an external vacuum source. A fixed structural distance between the inlet opening and the cutting assembly defines, under negative pressure, a minimum length of hair that can be cut, thereby defining a cutting length threshold through a fixed structural relationship. A skin isolation structure inhibits sealed contact at the inlet end while maintaining the inlet opening as the primary airflow entry.

### TECHNICAL FIELD

The present disclosure relates generally to personal grooming devices, and more particularly to a haircutting attachment configured to be driven by an external vacuum source without electrical power, and having a cutting length defined by a fixed structural relationship and an inlet structure configured to inhibit sealed skin contact.

### BACKGROUND

Haircutting devices commonly rely on electrically driven motors to actuate cutting elements. Such devices typically require electrical power supplies, wiring, and control components, which increase structural complexity and limit use scenarios.

Devices in which airflow is used in association with hair cutting have been proposed. However, such devices generally do not structurally define a cutting length threshold independent of user adjustment or electrical control, and may permit sealed contact between a user's skin and an inlet region during use.

Accordingly, there remains a need for a haircutting attachment that operates without electrical components, structurally defines a cutting length threshold, and inhibits sealed contact at an inlet end during operation.

### SUMMARY

The present disclosure provides a vacuum-powered haircutting attachment configured for connection to an external vacuum source. The attachment includes a housing defining an internal airflow passage, an inlet opening arranged as a primary airflow entry, and a cutting assembly disposed within the airflow passage and driven by airflow.

A fixed structural distance between the inlet opening and the cutting assembly defines, under negative pressure, a minimum length of hair that can be cut by the cutting assembly. Hair length control is thereby inherently imposed by a fixed spatial relationship between the inlet opening and the cutting assembly, rather than being selectively adjustable during use.

The attachment further includes a skin isolation structure positioned at the inlet end. In some embodiments, the skin isolation structure includes a raised peripheral guard and a plurality of relief slots configured to inhibit sealed contact at the inlet end while maintaining the minimum length of hair that can be cut as defined by the fixed structural distance.

### BRIEF DESCRIPTION OF THE DRAWINGS

FIG. 1 is an overall schematic view of a vacuum-powered haircutting attachment according to one embodiment.

FIG. 2 is a longitudinal cross-sectional view illustrating an airflow direction, a cutting assembly, a fixed structural distance defining a cutting length threshold, and an optional relief opening.

FIG. 3 is an enlarged view of an inlet end of the haircutting attachment, illustrating an inlet opening and a skin isolation structure.

### DETAILED DESCRIPTION

Reference will now be made to the drawings, wherein like reference numerals refer to like elements throughout.

### Overall Structure

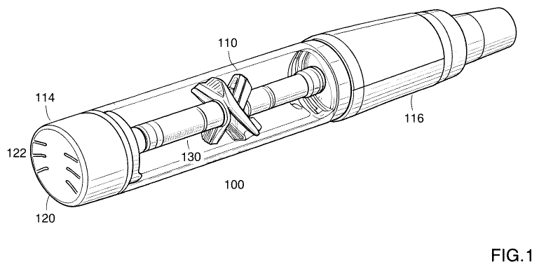

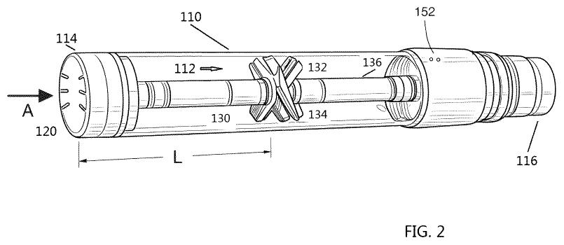

As shown in FIGS. 1 and 2, a vacuum-powered haircutting attachment 100 includes a housing 110 having a generally tubular configuration. The housing 110 defines an internal airflow passage 112 extending along a longitudinal axis between an inlet end 114 and a vacuum coupling end 116.

The vacuum coupling end 116 is configured for connection to an external vacuum source via a hose or conduit.

### Inlet End and Primary Airflow Entry

The inlet end 114 includes an inlet opening 120 configured to define an entry region for airflow into the airflow passage 112 under negative pressure. In some embodiments, the inlet opening 120 includes a plurality of sub-openings 122 formed as elongated slots in a generally flat inlet face.

As illustrated in FIG. 2, airflow enters the housing 110 at the inlet end 114 and flows in an airflow direction A toward the vacuum coupling end 116. The inlet opening 120 is arranged as a primary airflow entry into the airflow passage 112.

### Cutting Assembly

A cutting assembly 130 is disposed within the airflow passage 112 downstream of the inlet opening 120 along the airflow direction A. The cutting assembly 130 includes an airflow-driven member 132, a cutting element 134, and a shaft 136.

During operation, airflow generated by the external vacuum source impinges on the airflow-driven member 132, causing rotation of the shaft 136 and the cutting element 134.

In some embodiments, the cutting assembly may be repositioned along the longitudinal axis of the housing during manufacture or assembly.

### Structurally Defined Cutting Length

As illustrated in FIG. 2, the cutting assembly 130 is positioned at a fixed structural distance L from the inlet opening 120, measured along the airflow direction A.

Under negative pressure generated by the external vacuum source, the fixed structural distance L defines a minimum length of hair that must be reached in order for the hair to be cut by the cutting assembly 130. Hair having a length shorter than the fixed structural distance L is inhibited from reaching the cutting assembly 130 and therefore cannot be cut.

By defining the distance L as a fixed geometric relationship between the inlet opening 120 and the cutting assembly 130, the haircutting attachment 100 defines a cutting length threshold without electrical components or adjustable mechanical guards.

### Skin Isolation Structure

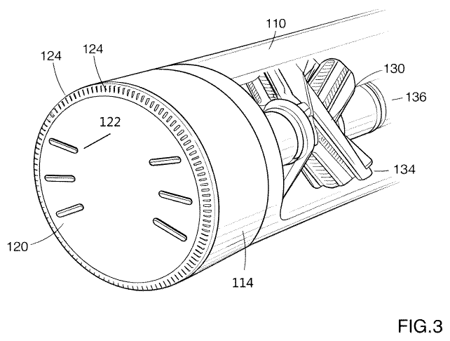

Referring to FIG. 3, a skin isolation structure 124 is positioned at the inlet end 114 and surrounds the inlet opening 120. The skin isolation structure 124 includes a raised peripheral guard configured to contact a user's skin prior to contact with the inlet opening 120.

In some embodiments, the skin isolation structure 124 includes a plurality of relief slots formed in the raised peripheral guard. The relief slots are configured to permit airflow through the skin isolation structure 124 while inhibiting sealed contact at the inlet end.

The inlet opening 120 remains the primary airflow entry into the airflow passage 112 such that airflow through the relief slots does not substantially alter the minimum length of hair that can be cut as defined by the fixed structural distance L.

### Optional Relief Openings

As shown in FIG. 2, the housing 110 may optionally include one or more relief openings 152 positioned downstream from the inlet end 114 and upstream from the vacuum coupling end 116.

The relief openings 152 provide an additional airflow path while being positioned such that they do not substantially affect the fixed structural distance L or the cutting length threshold defined thereby.

1. A vacuum-powered haircutting attachment, comprising:
a housing defining an internal airflow passage extending along a longitudinal axis between an inlet end and a vacuum coupling end, the housing being configured for connection to an external vacuum source;
an inlet opening formed at the inlet end and arranged as a primary airflow entry into the airflow passage under negative pressure;
a cutting assembly disposed within the airflow passage downstream of the inlet opening along an airflow direction;
wherein the cutting assembly is positioned at a fixed structural distance from the inlet opening measured along the airflow direction;
wherein the fixed structural distance defines, under negative pressure generated by the external vacuum source, a minimum length of hair that must be reached in order for the hair to be cut by the cutting assembly;
a skin isolation structure positioned at the inlet end and surrounding the inlet opening;
wherein the skin isolation structure includes a raised peripheral guard configured to contact a user's skin prior to contact with the inlet opening; and
wherein the skin isolation structure further includes a plurality of relief slots configured to permit airflow through the skin isolation structure while inhibiting sealed contact at the inlet end,
wherein the inlet opening remains the primary airflow entry such that airflow through the relief slots does not substantially alter the minimum length of hair that can be cut as defined by the fixed structural distance.

2. The haircutting attachment of claim 1, wherein the inlet opening comprises a plurality of elongated slots formed in a generally flat inlet face.

3. The haircutting attachment of claim 1, wherein the cutting assembly comprises a rotating cutting element mounted on a shaft and driven by airflow.

4. The haircutting attachment of claim 1, wherein the cutting assembly is positioned centrally within the airflow passage.

5. The haircutting attachment of claim 1, wherein the housing includes at least one relief opening positioned downstream from the inlet end.

6. The haircutting attachment of claim 5, wherein the relief opening is positioned such that the relief opening does not alter the fixed structural distance defining the minimum length of hair that can be cut.

7. The haircutting attachment of claim 1, wherein the haircutting attachment includes no electrical motor, battery, or electrical power source.

8. The haircutting attachment of claim 1, wherein the cutting assembly is configured to be movable along the longitudinal axis of the housing.

9. The haircutting attachment of claim 1, wherein the skin isolation structure is formed as an annular guard surrounding the inlet opening.

10. The haircutting attachment of claim 1, wherein the relief slots are configured as narrow, closely spaced openings formed in the raised peripheral guard.
